(19) United States
(12) Patent Application Publication
(10) Pub. No.: US 2015/0308495 A1
(43) Pub. Date: Oct. 29, 2015

(54) IMPROVED FOUR POINT CONTACT BALL BEARING IN TWO RACES AND AN IMPROVED DRESSER TO MANUFACTURE THE SAME

(71) Applicants: Dayalal Govindji FATANIA, GUJARAT (IN); SHARDAMANI TECHNICAL RESEARCH AND DEVELOPMENT PRIVATE LIMITED, Rajkot, Gujarat (IN)

(72) Inventor: Dayalal Govindji FATANIA, Porbandar, Gujarat (IN)

(73) Assignee: SHARDAMANI TECHNICAL RESEARCH AND DEVELOPMENT PRIVATE LIMITED, Rajkot, Gujarat (IN)

(21) Appl. No.: 14/437,102

(22) PCT Filed: Apr. 10, 2013
(86) PCT No.: PCT/IN2013/000237

§ 371 Date: Apr. 20, 2015

(30) Foreign Application Priority Data
Jun. 14, 2012 (IN) 1723/MUM/2012
Sep. 11, 2012 (IN) 2630/MUM/2012

(51) Int. Cl. F16C 19/16; B24B 53/08; F16C 33/64; B24B 19/06

(52) U.S. Cl. CPC F16C 19/166; B24B 19/06; B24B 53/081; F16C 33/64

(57) ABSTRACT

Problem to be solved by this Invention is to manufacture an Actual Four Point Contact Ball Bearing which reduces a self friction of Bearing by 50% in compared to Deep Groove Ball Bearing. Actual Four Point Contact Ball Bearing comprises an inner race (b1), an outer race (a1), balls (d11) & cage wherein inner race & outer race have a groove made up of two circular arcs forming a Gothic arch in which Balls are accommodated & kept in position with the help of cage. In this invention the balls have a point contact at 35° (c1) with races in groove forming a gothic arch. Actual Four Point Contact Dresser comprising a Base, a Stand, a Handle, a Bearing Assembly, a Cylinder, a Piston, a Gothic Arch Guide Plate, a Lever and a Diamond which in operation dresses a Grinding wheel in Gothic Arch Formation resulting in Grinding of Gothic Arch Grooves of Outer & Inner Races of Actual Four Point Contact Bearing.

This invention relates to four point contact ball bearing, particularly to four point contact ball bearing in two races and more particularly an actual four point contact ball bearing in two races with a contact angle of 35°.

This invention also relates to a method of manufacturing Actual Four Point Contact Ball Bearing in two races with any contact angle and An Improved Dresser to manufacture the same.

### BACK GROUND

Ball bearing is the heart of almost all the product with a Rotating Shaft.

Ball Bearing is widely manufactured across the world by machining the Races with a provision of Grooves to accommodate Balls. As shown in FIG. 1/2 Ball Bearings are manufactured with Outer Race, Inner Race, Cage & Balls.

Deep Groove Ball Bearing is manufacture with a Radial groove in both the races to accommodate Balls between them. Here Radial groove create a Line Contact Formations.

The instant invention results in ball bearing with low self friction, low heat generation & preserve Lubrication by Groove with a formation of Gothic arch in both the Inner & Outer race resulting in more self life.

Here we are also introducing a procedure to manufacture A4C Ball Bearing. Most Bearing Specifications & Tolerance are quantified in Micron (abbreviation of Micrometer) is One millionth of meter.

Repeatability in Manufacturing Process:—

Predictable uniformity or repeatability in manufacturing process is crucial to ensuring consistent performance of bearing.

The narrower the variation in each steps of manufacturing process, the greater the consistency of each Bearing's performance.

The object of the invention is to provide an improved method of manufacturing Actual Four Point Contact Ball Bearing in two races with any contact angle and An Improved Dresser to manufacture the same which reduces the variations and maintains predictable uniformity.

### SUMMARY OF THE INVENTION

1. In present Invention Grooves of both the races made up of two circular arcs forming a Gothic Arch as shown in FIG. 3-b.
2. Groove forming a Gothic arch accommodate the balls in between two races with a Point Contact at 35° as shown in FIG. 3-b (c1).
3. As per simple theory of Friction:—Friction is directly proportional to area so lesser the contact area friction is less.
4. Static friction Co efficient of Deep Groove Ball Bearing is 0.052 while Actual Four Point Contact Ball Bearing is 0.017.
5. So starting Torch required by using Actual Four Point Contact Ball Bearing is 50% less than Deep Groove Ball Bearing.
6. Rolling friction Co efficient of Deep Groove Ball Bearing varies from 0.0025 to 0.0042 while Actual Four Point Contact Ball Bearing is 0.00116.
7. So Friction Torch required by using Actual Four Point Contact Ball Bearing is 50% less than that of Deep Groove Ball Bearing.
8. As per point no. 2, there is a Point Contact between Races & Balls, therefore Bearing do not tampered while running for a long time.
9. Due to formation of Gothic arch there is a Gap as shown in FIG. 3-b (e1 & f1) between Ball surface & Groove which provide a space for preservation of Lubrication.
10. As per point no. 8 & 9 low heat generation restrict the changes in grain structure of material gives dimensional stability which increase a self life of Ball Bearing.
11. In Actual Four Point Contact Ball Bearing Balls have a Point Contact with Races in groove forming a Gothic arch results Equal Axial & Radial play.
12. As per point no. 11 Load Carrying capacity of Actual Four Point Contact Ball Bearing is increase that it can take also an Axial Load as well as Radial Load.
13. As per point no. 12 Actual Four Point Contact Ball Bearing can be a replacement of Roller Bearing, Angular Contact Ball Bearing & Thrust Bearing also.
14. As per point no. 5, 7, 8, 9 & 10 Use of Actual Four Point Contact Ball Bearing leads to a less Energy consumption & more life especially of Fuel in Automobile Vehicle.
15. As per point no. 5, 7, 8, 9 & 10 use of Actual Four Point Contact Ball Bearing in Electric Motor significantly reduce Power Consumption both in Household & Industrial equipment.
16. As per point no. 5, 7, 8, 9 & 13 Actual Four Point Contact Ball Bearing is a perfect for High Speed Machinery with a Heavy Load.

### BRIEF DESCRIPTION OF DRAWING

FIG. 1 shows a Parts of Actual Four Point Contact Ball Bearing Showing Point Contact.

FIG. 2 shows a Sectional View of Actual Four Point Contact Ball Bearing.

FIG. 3-a shows a Horizontal Cross Section of Full Contact Ball Bearing.

FIG. 3-b shows a Horizontal Cross Section of Actual Four Point Contact Ball Bearing.

FIG. 4 shows a Radial Dresser.

FIG. 5 shows a A4C Dresser.

FIG. 6 shows a Top view of A4C Dresser.

FIG. 7 shows a Section view of A4C Dresser.

FIG. 8 shows the process flow

### NOMENCLATURES IN FIGURE

### Nomenclatures in Figure

| | | |
|---|---|---|
| a1—Outer Race | a—Handle | h—Lever |
| b1—Inner Race | b—Cap | i—Diamond |
| c1—Contact Points | c—Shaft | k—Stand |
| d1—Balls | d—Ball Bearing | m—Base |
| e1—Gap | e—Housing | p—Piston |
| f1—Gap | f—Cylinder | w—Grinding Wheel |
| g1—Cage | g—Guide Plate | |
| A—Bearing Assembly | B—Cylinder Assembly | |

### DETAIL DESCRIPTION OF THE INVENTION

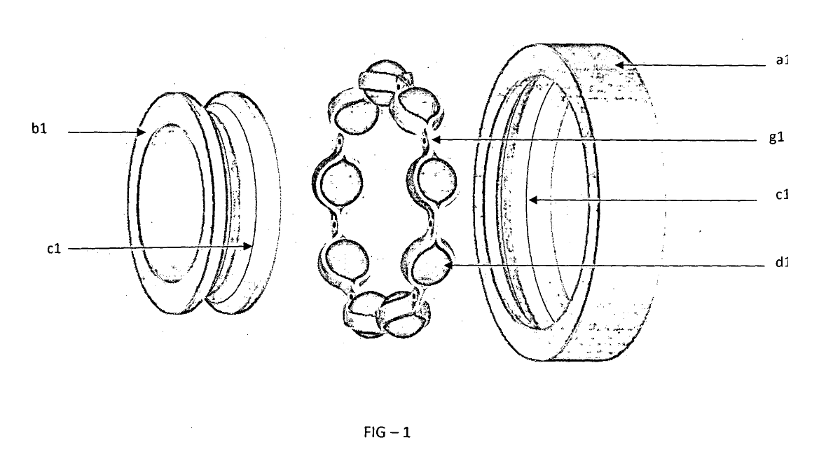

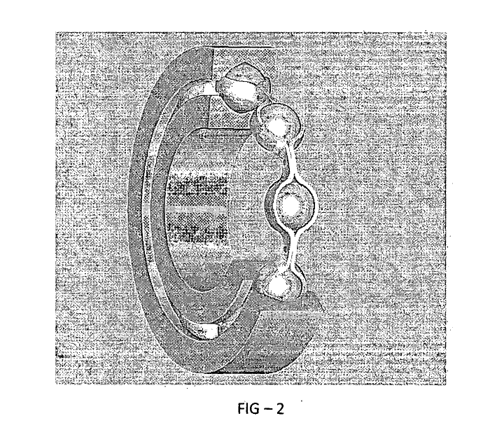

Actual Four Point Contact Ball Bearing comprises of an inner race (b1), an outer race (a1), balls (d1) & cage (g1) as shown in FIG. 1. Where inner race & outer race have a groove made up of two circular arcs forming a Gothic arch as shown in FIG. 2 in which Balls are accommodated & having in position with the help of cage.

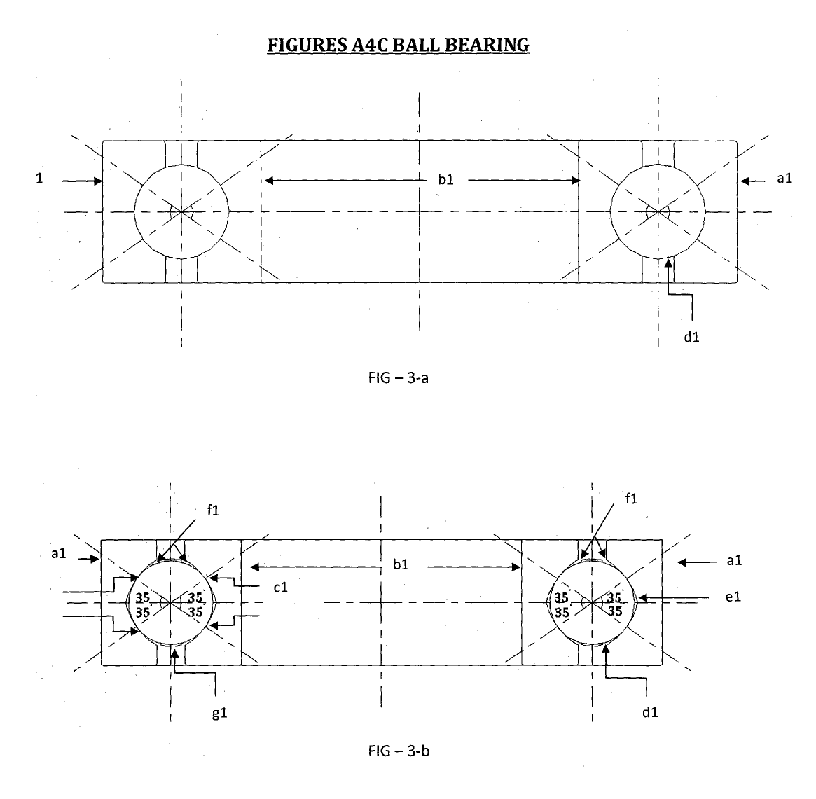

The Balls have a Point Contact at 35° FIG. 3-b with Races in groove forming a Gothic Arch (the angle between line joining the point of contact of the ball with the race and the centre of the ball and the minor axis of the arch is 35 degree).

By this invention, Self Friction is reduced by 50% as compared to Deep Groove Ball Bearing due to Lesser the Contact Area between Balls & Races.

In Actual Four Point Contact Ball Bearing of this invention, Static friction Co efficient is 0.017.

In Actual Four Point Contact Ball Bearing of this invention, Rolling Friction Co efficient is 0.00116.

By the application of Actual Four Point Contact Ball Bearing of this invention Required Starting Torch & Friction Torch is reduced by 50% as compared to Deep Groove Ball Bearing.

Due to lesser contact area & Lubrication preservation in Gap FIG. 3 (e1 & f1) heat generation is reduced and Self Life of Actual Four Point Contact Ball Bearing increase.

Actual Four Point Contact Ball Bearing of this invention have an Equal Axial & Radial play.

Actual Four Point Contact Ball Bearing of this invention have an ability to take both the Axial & Radial Load.

It can be a replacement of Roller Bearing, Angular Contact Ball Bearing & Thrust Bearing also.

It is perfect solution for all the Machines whether it is Automobile machines, Industrial machinery or an Electrical Equipment for Less Energy Consumption, more efficiency & Long life.

### Parts of A4C Ball Bearing:—

1. Outer Race:—As shown in FIG. 1 a1. Outer Race is outer most part of Bearing fit in Housing & made of Bearing steel SAE 52100/EN-31 in Circular shape with a groove in inner periphery to accommodate Balls.
2. Inner Race:—As shown in FIG. 1 b1. Inner Race is inner most part of Bearing Axle shaft is fitted inside the Bore & made of Bearing steel SAE 52100/EN-31 in Circular shape with a groove on outer periphery to accommodate Balls.
3. Ball:—As shown in FIG. 1 d1. Ball have a spherical shape & made of Bearing steel SAE 52100/EN-31 take place in between the grooves of both the Races.
4. Cage:—As shown in FIG. 1 g1. Cage have a Circular spiral shape & made of steel or Brass keep Balls in a position.

Manufacturing of A4C Ball Bearing involves manufacturing of Outer Race, Inner Race, Balls, and Cages & Assembly.

### PROCEDURE

### Prior Art

17. As shown in FIG. 1 Actual Four Point Contact Ball Bearings are manufactured with Outer Race, Inner Race, and Cage & Balls.
18. Actual Four Point Contact Ball Bearing is manufactured by machining the Races with a provision of Grooves with a formation of Gothic arch in both the Inner & Outer race to accommodate Balls as shown in FIG. 1. Here Gothic Arch grooves create a Point Contact Formation.
19. Manufacturing of ACTUAL FOUR POINT CONTACT Ball Bearing involves manufacturing of Outer Race, Inner Race, Balls, and Cages & Assembly.
20. Manufacturing Process of Outer Race & Inner Races of Actual Four Point Contact Ball Bearing involves Turning Operation, Hardening of Races, Grinding Operation & Assembly.
21. After Hardening Races becomes hard so further operation cannot be done in Lathe Machine with cutting tools. It is required to grind the Races in Grinder Machine with abrasive Grinding wheel.
22. Grinding Operation carried out in various Grinding machine over Hard Races for final finished shape & dimension, in which Races is revolves within its centre & rotating grinding wheel grind the Races in final finished shape & dimension.
23. Grinding of Gothic arch groove in inner rim of Outer Race is being carried out on Internal Track grinder by Dressed grinding wheel in Gothic arch shape with Plunge-grinding Techniques.
24. Grinding of Gothic arch groove in outer rim of Inner Race is being carried out on External Track grinder by Dressed grinding wheel in Gothic arch shape with Plunge-grinding Techniques.
25. To get a Gothic Arch Grooves of particular shape & dimension, In Track Grinder Abrasive Grinding wheel needs to dress in required shape & dimension of Gothic Arch Grooves.
26. Dressing of Grinding wheel is essential & being done with a Rotary type Diamond Dresser this is ACTUAL FOUR POINT CONTACT Dresser.
27. Finally Grinded Races with final finish shape & dimension is dispatched for Assembly.

1. Turning Operation:—
Both the Inner & Outer Races are usually machined from Forged Ring manufactured from Bearing steel SAE 52100/EN-31 as a Raw material.
Turning operation are divided into various lathe operation i.e. Face, OD, Bore, grooves, Radius, Chamfer. All these operations are done on production Lathe Machine.
On Lathe machine OD & Bore of required dia. Is made with the help of cutting tool, maintaining Tolerance for grinding operation.
A groove of Gothic shape is being carved in inner rim of Outer Race & outer rim of Inner Race with a Tolerance for grinding operation.
Then Radius & Chamfer carved as per standard practice.

2. Heat Treatment of Races:—
Heat Treatment is given to Turned Races to achieve required Hardness of 60 to 62.
To achieve a required Hardness Turned Races is now kept in a Furnace & then quenching the same in Oil media at Room Temperature.

3. Grinding Operation:—
After getting a Hardness Races cannot be Turn on Lathe Machine by cutting tools, So Grinding Operation start in order to give final shape & dimension.
Grinding Operation further divided into Face grinding, OD grinding, Bore grinding, Gothic arch groove grinding.
All operations are done in various Grinder machine by revolving races & grinding by rotating Abrasive grinding wheel for final shape & dimension.
Flat surface of Races is to be grinded on Surface Grinder for the final finished Width of A4C Ball Bearing.
Outer Rim of Outer Race & Inner Race is to be grinded in Centre less Grinder for the final finished Outer Diameter of A4C Ball Bearing.
Inner Rim of Outer Race & Inner Race is to be grinded on Bore Grinder for the final finished Bore of A4C Ball Bearing. This is carried out form Dressed grinding wheel with Plunge-grinding Techniques.
Up to now there is a normal Operation as per the set procedure of Deep Groove Ball Bearing in General practice.
Now for Grinding of Grooves in Races by using A4C Dresser.
Grinding of Gothic arch groove in inner rim of Outer Race is being

carried out on Internal Track grinder by Dressed grinding wheel in Gothic arch shape with Plunge-grinding Techniques.
Grinding of Gothic arch groove in outer rim of Inner Race is being

carried out on External Track grinder by Dressed grinding wheel in Gothic arch shape with Plunge-grinding Techniques.
In Grinding of Gothic Arch groove grinding wheel is required to Dress in Gothic arch shape is being done by A4C Dresser.
A4C Dresser is a Rotary Type Dresser.

4. Assembly:—
Finally Races. Balls & Cages which have been manufactured in different location comes together for Assembly.
Outer & Inner diameter of Raceways measured separately.
By selecting suitable combination of Races & Balls, the required internal clearance obtained.
Balls are fed between the Races equally spaced before the two cage halves fitted & then Riveted together.
After washing final inspection sequence start. This consists of running accuracy, Vibration level, Outside & Bore diameter, as well as Axial & Radial clearance.
Now it is a complete A4C Ball Bearing is washed, coated with preservative, greased & being packed for dispatch.

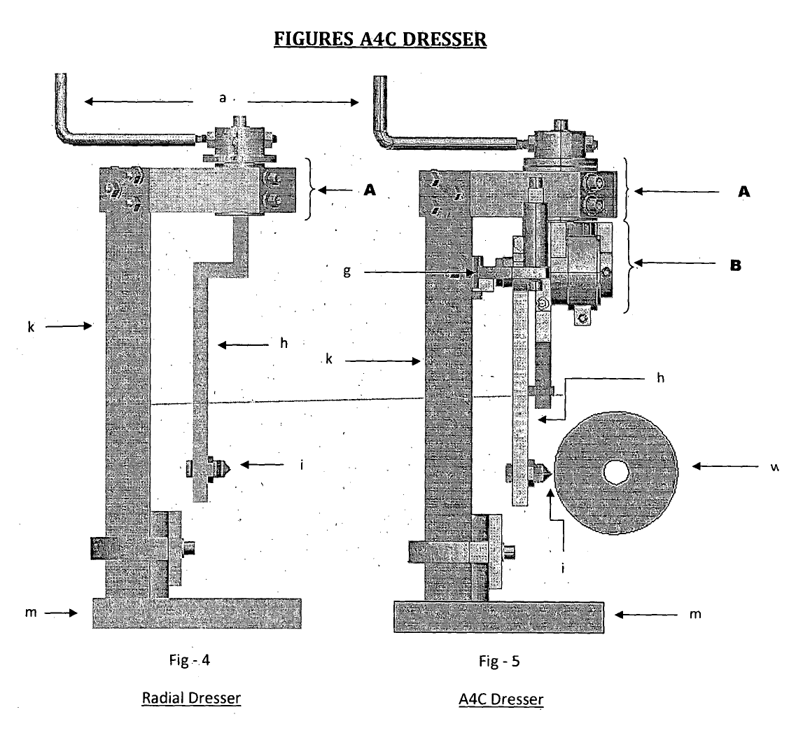

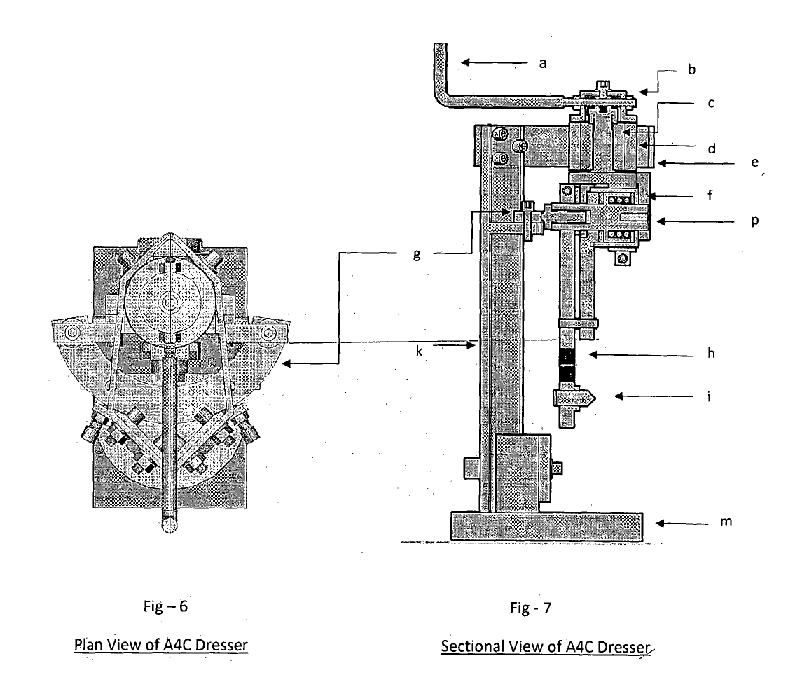

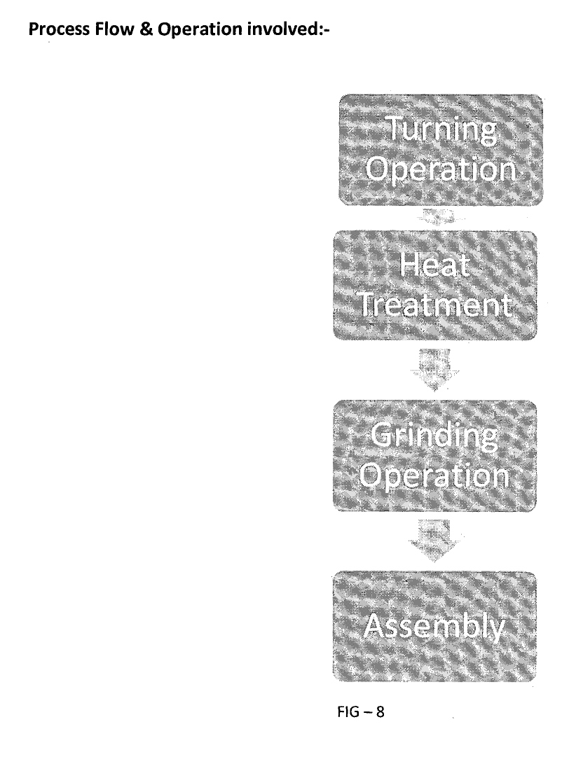

Related Art:—
1. Radial Dresser as shown in FIG. 4 is widely used in Grinding Operation to manufacture Deep Groove Ball Bearing as shown in FIG. 3-a with a Radial groove in both the races to accommodate Balls between them. Here Radial groove create a Line Contact Formation.
2. In Radial by swinging a Handle FIG. 4(a), Diamond FIG. 4 (i) fitted on Lever FIG. 4 (h) moves in circular path through Bearing Assembly FIG. 4 (A) Dress a Grinding wheel in Radial Formation.
3. In present Invention, Actual Four Point Contact Dresser shown in FIG. 5 is Dress the Grinding Wheel in Gothic Arch Formation.
4. In ACTUAL FOUR POINT CONTACT Dresser of FIG. 5, Diamond FIG. 5 (i) fitted on Lever FIG. 5 (h) is attached with Cylinder Assembly FIG. 5 (B) which is connected with Bearing Assembly FIG. 5 (A) & Contacted with Gothic Arch Guide Plate FIG. 5 (g).
5. Bearing Assembly of ACTUAL FOUR POINT CONTACT Dresser comprising of Shaft FIG. 7 (c) fitted in Set of Bearing FIG. 7 (d) fixed in Housing Fig (e) attached with Stand FIG. 7 (k) entire Assembly covered by Cap FIG. 7 (b).
6. Cylinder Assembly comprising of Piston FIG. 7 (p) fitted in Cylinder FIG. 7 (f) & Contacted with Gothic Arch Guide Plate FIG. 7 (g).
7. Actual Four Point Contact Dresser has been fixed at Grinding Machine Bed on Base FIG. 5 (m).
8. Set the Grinding wheel FIG. 5 (w) near by Diamond FIG. 5 (i).
9. By Swinging a Handle FIG. 7 (a) attached with Shaft FIG. 7 (c) of Bearing Assembly in half circle connected Cylinder FIG. 7 (f) follows same movements with the help of Bearing Assembly.
10. At the same time Piston FIG. 7 (p) fitted in Cylinder FIG. 7 (f) slides on Gothic Arch Guide Plate FIG. 7 (g).
11. While sliding on Gothic Arch Guide Plate FIG. 7 (g) due to spring action Piston FIG. 7 (p) get Horizontal movement as per Gothic Arch Guide Plate shape.
12. Both the Circular & Horizontal movement of Piston FIG. 7 (p) Results to form a Gothic Arch Formation.
13. Finally Diamond FIG. 7 (i) fixed in Lever FIG. 7 (h) attached with Piston FIG. 7 (p) moves as per Gothic Arch Guide Plate FIG. 6/7 (g) & Dress the Grinding wheel FIG. 5 (w) in required shape of Gothic Arch Groove FIG. 9.
14. Here Bearing Assembly gives a Circular movement while Gothic Arch Guide Plate FIG. 6/7 (g) Guide the Diamond FIG. 7 (i) to form a Gothic Arch Formation on Grinding Wheel.
15. Dressed Grinding wheel FIG. 5 (w) As per Point No 13 now Grind the Gothic Arch Groove FIG. 9.
16. Size of Gothic Arch groove can be maintained by adjusting a diamond on Lever.
17. As per Point No. 15 & 16 Gothic Arch Groove is being Grind in inner rim of Outer Race & outer rim of Inner Race of Internal Track Grinder & External Track Grinder Machine respectively by Plunge Grinding method.
18. Outer Race FIG. 1 (a1) & Inner Race FIG. 1 (b1) then dispatched for Assembly.
19. Finally Races FIG. 1 (a1 & b1), Balls FIG. 1 (d1) & Cages FIG. 1 (g1) which have been manufactured in different location comes together for Assembly.
20. Actual Four Point Contact Ball Bearing FIG. 2 is being manufactured.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

1. A four point contact ball bearing comprising:
an inner race;
an outer race;
a plurality of balls; and
a cage;
wherein the inner race and the outer race each have a groove made up of two circular arcs forming a gothic arch;
wherein the balls are accommodated between the groove of the inner race and the groove of the outer race; and
wherein the balls are held in position by the cage.

2. The four point contact ball bearing as claimed in claim 1, wherein the balls have a point contact at 35° with races in the grooves forming the gothic arches.

3. The four point contact ball bearing as claimed in claim 2, wherein self friction is reduced by 50% as compared to a deep groove ball bearing.

4. The four point contact ball bearing as claimed in claim 2, wherein a coefficient of static friction is 0.017.

5. The four point contact ball bearing as claimed in claim 2, wherein a coefficient of rolling friction is 0.00116.

6. The four point contact ball bearing as claimed in claim 2, wherein gaps are provided between the balls and the grooves for accommodating lubrication, thereby reducing heat generation.

7. The four point contact ball bearing as claimed in claim 1, wherein an axial play is the same as a radial play.

8. A four point contact dresser comprising a base, a stand, a handle, a bearing assembly, a cylinder, a piston, a gothic arch guide plate, a lever and a diamond;
wherein the diamond is operational to dress a grinding wheel in a gothic arch formation.

9. The four point contact dresser of claim 8, wherein the dresser can dress the grinding wheel in the gothic arch formation for different contact angles by using the gothic arch guide plate.

10. The four point contact dresser of claim 8, wherein the dresser can dress the grinding wheel in the gothic arch formation for different ball sizes.

11. The four point contact dresser of claim 8, wherein the stand is mounted on the base;
wherein a cylinder assembly, including the cylinder, is mounted on the stand, the cylinder assembly is connected to the bearing assembly and contacted with the gothic arch guide plate;
wherein the diamond is fixed to the lever which is attached to the cylinder assembly;
wherein the bearing assembly includes a shaft fitted in a bearing fixed in a housing attached to the stand, and the bearing assembly is covered by a cap;
wherein the cylinder assembly includes the piston fitted in the cylinder and in contact with the gothic arch guide plate;
wherein the grinding wheel is set near to the diamond;
wherein, by swinging the handle attached to the shaft of the bearing assembly in half circle, the connected cylinder follows the same movements with the help of the bearing assembly and at the same time, the piston fitted in the cylinder slides on the gothic arch guide plate, while sliding on the gothic arch guide plate due to spring action the piston moves horizontally relative to the cylinder as per the gothic arch guide plate shape, and both the circular and the horizontal movements of the piston result to form the gothic arch formation; and
wherein the diamond fixed to the lever attached to the piston moves as per the gothic arch guide plate to dress the grinding wheel with the gothic arch formation.

12. A method of manufacturing a four point contact ball bearing in two races with a contact angle, the method comprising:
grinding gothic arch groove in an inner rim of an outer race on an internal track grinder using a dressed grinding wheel in gothic arch shape with plunge-grinding techniques using the four point contact dresser according to claim 8; and
grinding a gothic arch groove in an outer rim of an inner race on an external track grinder using a dressed grinding wheel in gothic arch shape with plunge-grinding techniques using the four point contact dresser according to claim 8.

13. (canceled)
